(19) United States
(12) Patent Application Publication
(10) Pub. No.: US 2009/0040314 A1
(43) Pub. Date: Feb. 12, 2009

(54) METHOD FOR RECORDING IMAGES IN ELECTRONIC DEVICE

(75) Inventors: Chun-Kai CHAN, Taipei (TW); Li-Hsiang Liao, Taipei (TW); Ya-Shu Juang, Taipei (TW)

Correspondence Address: Muncy, Geissler, Olds & Lowe, PLLC, P.O. BOX 1364, FAIRFAX, VA, 22038-1364, US

(73) Assignee: ASUSTek COMPUTER INC., Taipei (TW)

(21) Appl. No.: 12/188,732

(22) Filed: Aug. 8, 2008

(30) Foreign Application Priority Data
Aug. 9, 2007 (TW) 96129456

(51) Int. Cl. H04N 5/225

(52) U.S. Cl. 348/207.1; 348/E05.024

(57) ABSTRACT

A method for recording images in an electronic device is disclosed. The method includes the following steps. A scheduled time is set, and auto-login information is written into a registry of the electronic device. The electronic device enters a sleep state or a shutdown state. The state of the electronic device is switched to an operation state from the sleep state or the shutdown state, and the electronic device executes an auto-login according to the registry. Then, images are recorded at the scheduled time.

### RELATED APPLICATIONS

This application claims priority to Taiwan Application Serial Number 96129456, filed Aug. 9, 2007, which is herein incorporated by reference.

### BACKGROUND OF THE INVENTION

1. Field of the Invention

The invention relates to a method for recording images in an electronic device and, more particularly, to a method for recording images in an electronic device with the function of auto-login.

2. Description of the Related Art

With the development of the information science and technology, the computer products are used more and more widely. Consumers demand more and more for the functions of the computer product, and the number of the peripheral electronic devices in the computer system increases. Many consumers choose to add a TV card or a TV adaptor to watch television programs using a computer screen. Such TV multimedia devices are particularly convenient for students and tenants whose living spaces are limited.

### BRIEF SUMMARY OF THE INVENTION

One objective of the invention is to provide a method for recording images in an electronic device at a scheduled time.

According to a preferred embodiment of the invention, a method for recording images in an electronic device is provided. The method includes the following steps. A scheduled time is set. Auto-login information is written to a registry of an electronic device. The electronic device enters a sleep state or a shutdown state. Before the scheduled time is up, the state of the electronic device is switched to an operation state from the sleep state or the shutdown state, and an auto-login is executed according to the registry. At last, the image is recorded at the scheduled time. When the state of the electronic device is switched to the operation state from the sleep state or the shutdown state, the operating system (OS) of the electronic device has a request for logining to a user account. The step of writing auto-login information includes the step of choosing a user account and a user password. The method for recording images in an electronic device further includes the step of encrypting the user password to avoid leaking. The electronic device may be a personal computer, and the operating system may be the Windows XP operating system or Windows Vista operating system of Microsoft.

In the method for recording images in an electronic device, an auto-login option may be added to the scheduled recording operation menu. A user only need to choose the auto-login option, the program writes the auto-login information to the registry. Thus, when the scheduled recording is executed, the personal computer in the sleep state or the shutdown state may automatically be logged in, and the state thereof is switched to the operation state to finish recording the images.

### BRIEF DESCRIPTION OF THE DRAWINGS

FIG. 1 is a flow chart showing a method for recording images in an electronic device according to a preferred embodiment of the invention; and

FIG. 2 is a flow chart showing a method for recording images in an electronic device according to another preferred embodiment of the invention.

### DETAILED DESCRIPTION OF THE EMBODIMENTS

These and other features, aspects, and advantages of the present invention will become better understood with regard to the following description, appended claims, and accompanying drawings.

The scheduled recording of the television program in a computer is very popular. When a computer is waked up from a sleep state, if the operating system has a request for logining to a user account and a password, and the user is absent, the computer picture stands at the login picture, and then the scheduled recording cannot be finished.

The operating system is set differently. When some computers are waked up from a sleep state or a shutdown state, they request users to input a password and login a user account, and then computer enters the desktop to execute the scheduled recording. If the user is absent when the computer is waked up, the scheduled recording cannot be executed successfully. If the computer keeps in the mode of auto-login, the security of the data in the computer is affected. Someone modifies the parameter setting in the registry to allow the operating system to be logged in automatically when the computer is waked up to execute the scheduled recording, and after the scheduled recording is finished, the parameter value is modified to be the original one manually, which is complex and cannot be used by a common user easily.

Therefore, the invention provides a method for recording images in an electronic device. An auto-login function is added to the scheduled recording operation menu to allow a user to choose the setting on the operation menu. Thus, the setting of auto-login in the scheduled recording is finished to actually execute the scheduled recording.

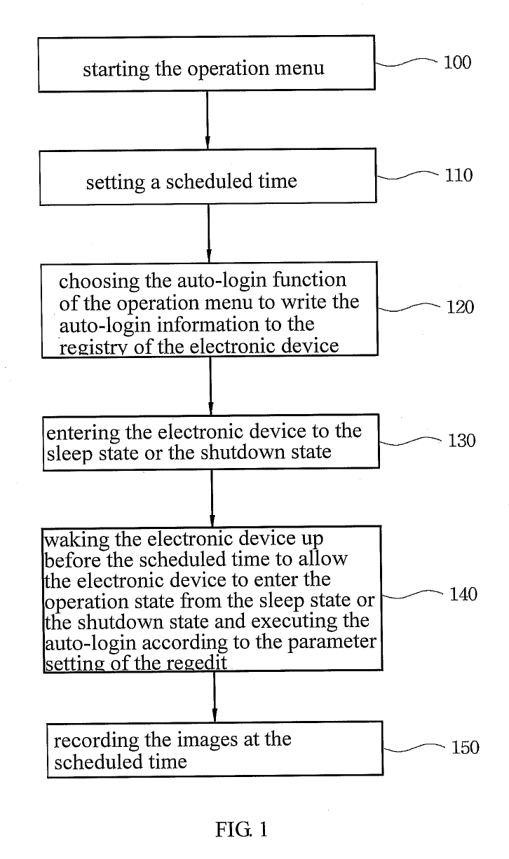

As shown in FIG. 1, FIG. 1 is a flow chart showing a method for recording images in an electronic device according to a preferred embodiment of the invention. The method for recording images in an electronic device is applied to an electronic device whose operating system has a request for logining to a user account when the computer device enters to an operation state from the sleep state or a shutdown state. The method for recording images in an electronic device begins with the step 100 in which, the operation menu is started to allow a user to operate the function setting in the scheduled recording page. Then, in the step 110, a scheduled time is set. In the step 120, the function of auto-login in the operation menu is chosen to allow the auto-login information to be written to the registry of the electronic device. In the step 110, the operating system of the electronic device sets a wakening time according to the inputted scheduled time. The wakening time is set to be slightly earlier than the scheduled time. In the step 120 which is writing the auto-login information to the registry of the electronic device, a user only needs to choose the auto-login option in the scheduled recording page, and the program enters the registry to modify the parameter setting in the registry. In the process of scheduled recording, the electronic device may automatically login the operating system to execute the preset function of recording images.

In the step 130, the electronic device enters the sleep state or the shutdown state. In the step 140, the electronic device is waked up before the scheduled time to allow the electronic device to enter the operation state from the sleep state or the shutdown state. Since the parameter setting of the registry is modified in the step 120, the electronic device executes the auto-login according to the parameter setting of the registry. At last, in the step 150, the images are recorded at the scheduled time.

The electronic device of the embodiment of the invention may be a personal computer, and the operating system is set to have a request for logining to the user account, and it is, for example, a Windows XP operating system or Windows Vista operating system. In this way, user only needs to choose the setting of the operation menu to finish the auto-login setting in the process of scheduled recording.

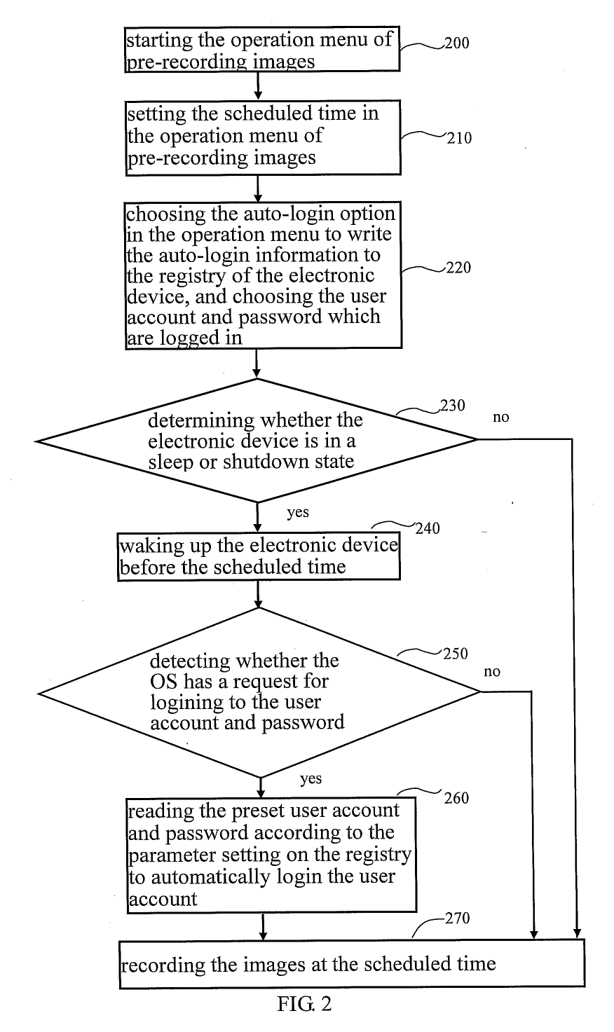

FIG. 2 is a flow chart showing a method for recording images in an electronic device according to another preferred embodiment of the invention. The method includes the following steps. In the step 200, the scheduled recording operation menu is started. In the step 210, the scheduled time is set in the scheduled recording operation menu. In the step 220, the auto-login option in the operation menu is chosen to write the auto-login information to the registry of the electronic device. In the step 220, the user account and password which are logged in may be chosen. After a period of time, before the scheduled time is up, in the step 230, whether the electronic device is in the sleep state or the shutdown state is determined. If it is in the sleep state or the shutdown state, in the step 240, the electronic device is waked up before the scheduled time is up. In the step 230, if the electronic device is not in the sleep state or the shutdown state, the step 270 which is recording the images at the scheduled time is directly executed.

The step 240 which is waking up the electronic device also includes the step of starting the electronic device or allowing the electronic device to depart from the sleep state and to enter the operation state from the sleep state or the shutdown state. Afterward, in the step 250, whether the operating system has a request for logining to a user account and a password is determined. If yes, the step 260 is executed, and the operating system reads the preset user account and the password according to the parameter setting on the registry to automatically login to the preset user account. At last, in the step 270, the images are recorded at the scheduled time. In the step 250, if the operating system does not have a request for logining to the user account, the step 270 which is recording images at the scheduled time is directly executed. To avoid spiteful someone steals the user password by program such as horse, in the step 220, the user password may be encrypted to avoiding leaking.

From the preferred embodiment of the invention, the invention has following advantages. In the method for recording images in an electronic device, an auto-login option is added to the scheduled recording operation menu. A user only needs to choose the auto-login option, the program writes the auto-login information to the registry to allow the personal computer in the sleep state or the shutdown state to be logged in automatically and to enter the operation state in the process of the scheduled recording to finish recording the images.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for recording images in an electronic device, comprising the steps of:
setting a scheduled time;
writing auto-login information to a registry of the electronic device;
making the electronic device enter into a sleep state or a shutdown state;
before the scheduled time is up, switching the state of the electronic device from the sleep state or the shutdown state to an operation state, and executing an auto-login according to the registry; and
recording the images at the scheduled time.

2. The method for recording the images in the electronic device according to claim 1, when the state of the electronic device is switched to the operation state from the sleep state or the shutdown state, an operating system of the electronic device has a request for logining to a user account before executing the auto-login according to the registry.

3. The method for recording the images in the electronic device according to claim 2, wherein the step of writing the auto-login information comprises the step of choosing the user account.

4. The method for recording the images in the electronic device according to claim 2, wherein the step of writing the auto-login information comprises the step of setting a user password of the user account.

5. The method for recording the images in the electronic device according to claim 4, further comprising the step of encrypting the user password.

6. The method for recording the images in the electronic device according to claim 1, wherein the electronic device is a personal computer.

7. The method for recording the images in the electronic device according to claim 6, wherein the operating system is a Windows Vista operating system of Microsoft.

8. The method for recording the images in the electronic device according to claim 6, wherein the operating system is a Windows XP operating system of Microsoft.

9. The method for recording the images in the electronic device according to claim 1, wherein the step of writing the auto-login information to the registry of the electronic device comprises the step of choosing an auto-login option of an operation menu.
